(19) United States
(12) Patent Application Publication
(10) Pub. No.: US 2005/0221866 A1
(43) Pub. Date: Oct. 6, 2005

(54) Emergency notification method and mobile communication device using the same

(76) Inventors: Hsing-Wei Huang, Banqiao City (TW); Chun-Ying Chiang, Caotun Township (TW)

Correspondence Address: RABIN & Berdo, PC, 1101 14TH STREET, NW, SUITE 500, WASHINGTON, DC, 20005, US

(21) Appl. No.: 10/927,088

(22) Filed: Aug. 27, 2004

(30) Foreign Application Priority Data
Apr. 1, 2004 (TW) 93109042

(51) Int. Cl. H04M 11/04

(52) U.S. Cl. 455/567

(57) ABSTRACT

An emergency notification method. The emergency notification method can be implemented in a mobile communication device capable of wireless connection to a telecommunication system providing telephone and messaging service. The mobile communication device comprises an initiation device and a speaker. The initiation device is activated to automatically implement the following emergency notification process comprising the following steps. The speaker is activated to emit a high volume ring tone. At least a predetermined parameter is first identified to determine whether to send a predetermined distress message through the telecommunication system. If the mobile communication device is directed to send the predetermined distress message, the predetermined distress message is transmitted through the telecommunication system.

### BACKGROUND

The present invention relates to a mobile communication device, and in particular to a mobile communication device capable of performing automatically emergency notification functions.

Mobile phones typically lack a physical protection mechanism. Physical protection mechanisms, such as siren, may be adopted. A physical protection device, however, may be cumbersome.

Further, even though an emergency number can be called, it may be inconvenient to dial the emergency number in an emergency situation. For example, a user may forget or not know the emergency number. With a mobile phone comprising a hinged cover, a mobile user must lift the hinged cover to dial the emergency number wasting seconds.

Some mobile phones comprise a global positioning system (GPS) receiver, capable of global positioning functions. Global positioning functions, however, are provided for a fee by a service provider. Not all telecommunication service providers support GPS functions, and not all mobile users order the same. Thus, a non-subscribed cannot be located by GPS in an emergency situation.

Hence, there is a need for emergency notification method ameliorating the above-described disadvantages.

### SUMMARY

Accordingly, the some embodiments of the invention provide an emergency notification method. The emergency notification method can be implemented in a mobile communication device capable of wireless connection to a telecommunication system providing telephone and messaging service. The mobile communication device comprises an initiation device and a speaker. The initiation device is activated to automatically implement the following emergency notification process. First, the speaker is activated to ring at a high volume. At least a predetermined parameter of the mobile communication device is identified to determine whether to send a predetermined distress message through the telecommunication system. If the mobile communication device is directed to send the predetermined distress message, the predetermined distress message is transmitted through the telecommunication system.

Additionally, some embodiments of the invention provide a mobile communication device. The mobile communication device comprises an initiation unit, a speaker, a memory, a communication unit, and a processing unit. The initiation unit may be a button, voice command device, or other input devices for initiating emergency functions. The processing unit is coupled to the initiation unit, speaker, memory, and communication unit. The mobile communication device is capable of wireless connection via a telecommunication system providing telephone and messaging service. The initiation unit activates emergency notification functions to be automatically implemented. The speaker is used for sounding audio signals. The memory is used for storing at least a predetermined parameter. The communication unit initiates a wireless communication channel to the telecommunication system. When the initiation unit is activated, the processing unit activates the speaker to ring at a high volume, determines whether the predetermined parameter is a direction to send a predetermined distress message through the telecommunication system. If so, the predetermined distress message is transmitted through the wireless communication channel and the telecommunication system.

### DESCRIPTION OF THE DRAWINGS

Embodiments of the invention can be more fully understood by reading the subsequent detailed description and examples with references made to the accompanying drawings, wherein:

FIG. 1 is a block diagram of the configuration of a mobile phone 10 according to embodiments of the invention;

FIG. 2 is a schematic diagram of the mobile phone according to embodiments of the invention;

FIG. 3 is a schematic diagram of a telecommunication system; and

FIG. 4 is a flowchart of the emergency notification method according to embodiments of the invention.

### DETAILED DESCRIPTION

Embodiments of the invention provide an emergency notification method implemented in a mobile phone. Although the mobile phone is illustrated as an example herein, this is not intended to limit the invention. The emergency notification method may be implemented in other mobile communication devices, such as a personal digital assistant, a camera or a video game device, combined with a mobile phone.

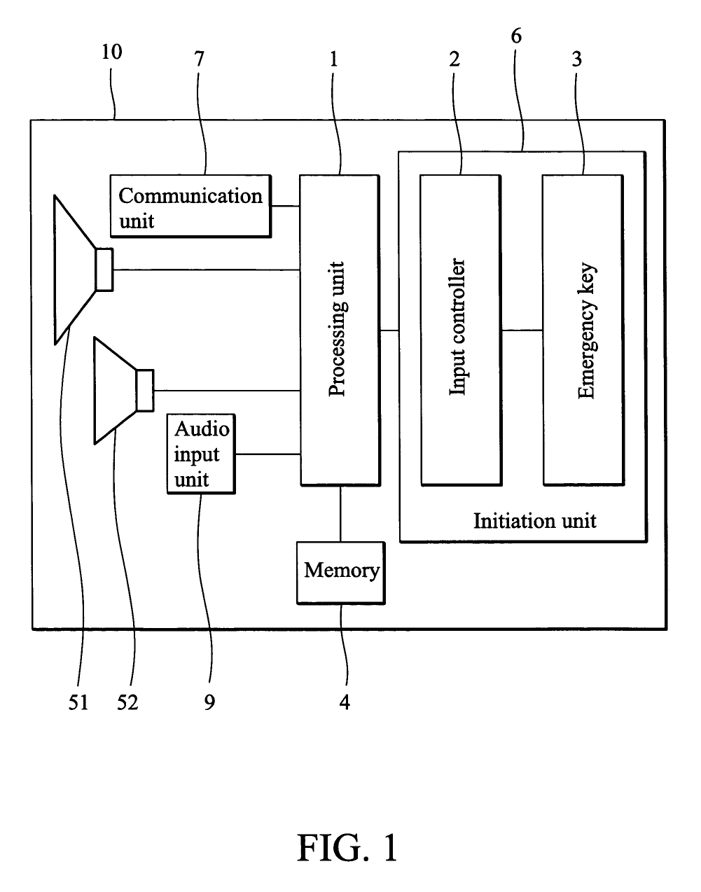

FIG. 1 is a block diagram of the configuration of a mobile phone 10 of an embodiment of the invention. Mobile phone 10 comprises a processing unit 1, a memory 4, a first speaker 51, a second speaker 52, an initiation unit 6, a communication unit 7 and an audio input unit 9. Initiation unit 6 is used for initiating an emergency notification process to perform at least an emergency function. Initiation unit 6 further comprises input controller 2 and an emergency key 3. Communication unit 7 is used for wireless communication.

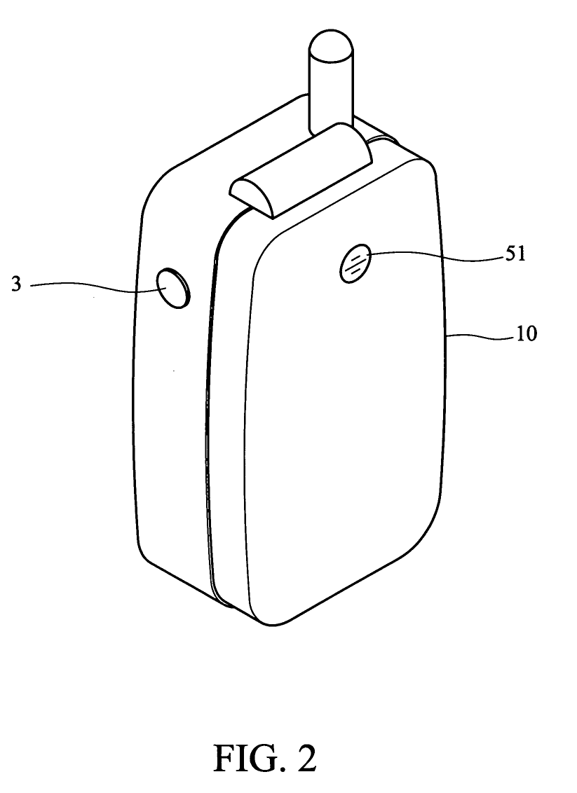

FIG. 2 is a schematic diagram of the mobile phone of an embodiment of the invention. Mobile phone 10 is provided with a hinged cover. Emergency key 3 may be disposed on in a side of mobile phone 10, as shown in FIG. 2. Thus, emergency key 3 can be pressed to initiate the emergency process without lifting the hinged cover. Emergency key 3 may be disposed at another location on mobile phone 10. First speaker 51 is used as a loudspeaker for output of a buzzer, ringing or vocal alert at high volume. Thus, first speaker 51 may be disposed on the outer side of the hinged cover, as shown in FIG. 2. Second speaker 52 outputs voice or other audio signals at a less volume. Audio input unit 9 receives a vocal signal.

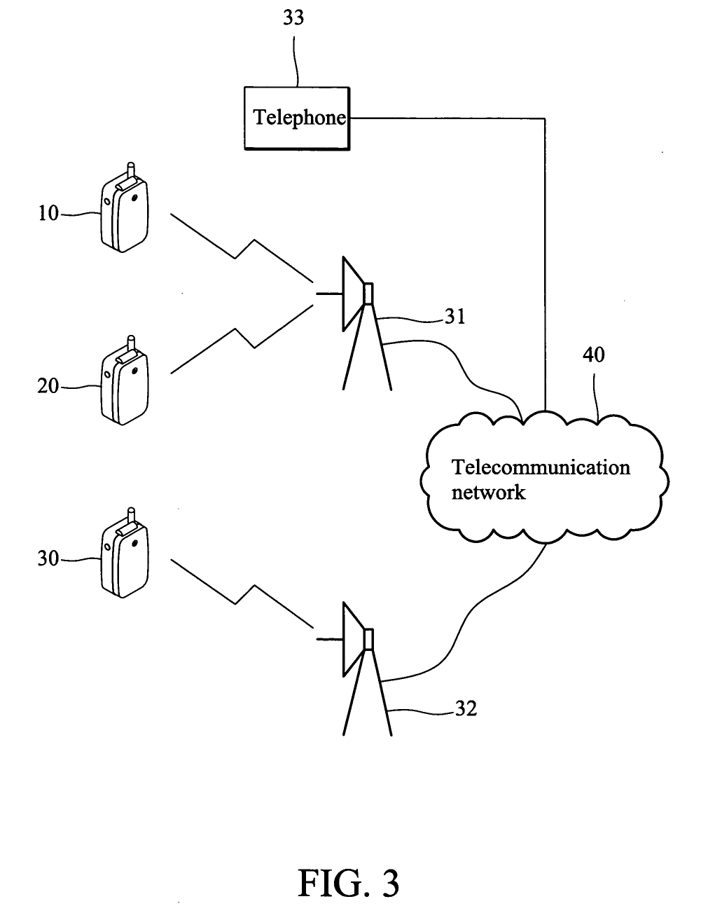

FIG. 3 is a schematic diagram of a telecommunication system. The telecommunication system comprises a telecommunication network 40, base stations 31 and 32, mobile phone 10-30, and wired telephone 33. Base stations 31 and 32 and telephone 33 are connected with telecommunication network 40. Mobile phone 10 and 20 access telecommunication network 40 through base station 31 using wireless signals. Mobile phone 30 accesses telecommunication network 40 through base station 32 using wireless signals. Mobile phones 10-30 are capable of communication with other terminals connected to telecommunication network 40.

For example, the telecommunication system may conform to the Global System for Mobile Communications (GSM) standard. Users of mobile phone 20 and 30 are, for example, relatives and friends of the user of mobile phone 10 respectively, and telephone 33 belongs to a police office nearest to mobile phone 10.

The user of mobile phone 10 may define in advance which emergency notification functions are triggered when an initiation condition is satisfied. The initiation condition will be described later. The emergency notification functions may comprise calling an emergency phone number or sending a distress message. In an embodiment, the distress message conforms to at least Short Messaging Services (SMS), Enhanced Messaging Services (EMS) or Multimedia Messaging Services (MMS) protocol. The distress message may comprise text, images or an audio clip. Telephone and messaging services are more popular in mobile phones than GPS services because they are widely supported by a plurality of wireless telecommunication systems, such as GSM, Digital Communication Services (DCS), Personal Communications Services (PCS), Personal Handyphone System (PHS). Further, an additional device for GPS is not necessary.

Predetermined emergency phone numbers, predetermined messaging addressees and predetermined messages can be defined by the user of mobile phone 10. Definition of emergency notification functions is recorded in a plurality of predetermined data stored in memory 4. The predetermined data comprise a calling parameter, a message parameter, a predetermined emergency phone number, predetermined messaging addressees and predetermined messages.

The call parameter states whether the predetermined emergency phone number will be called when the initiation condition is satisfied. A call parameter with value “1” represents yes. The call parameter with value “0” represents no.

The message parameter states whether the predetermined message will be sent to the predetermined message addressees when the initiation condition is satisfied. A message parameter with value “1” represents yes. The message parameter with value “0” represents no.

The predetermined emergency phone number comprises a phone number, such as the phone number of telephone 33 or “112”, to be called when the initiation condition is satisfied.

Predetermined message addressees comprise at least a recipient phone number, such as the phone number of mobile phone 20 or 30, to which the predetermined messages will be sent when the initiation condition is satisfied.

Predetermined messages comprise at least a record of predetermined message content to be sent to the predetermined message addressees when the initiation condition is satisfied.

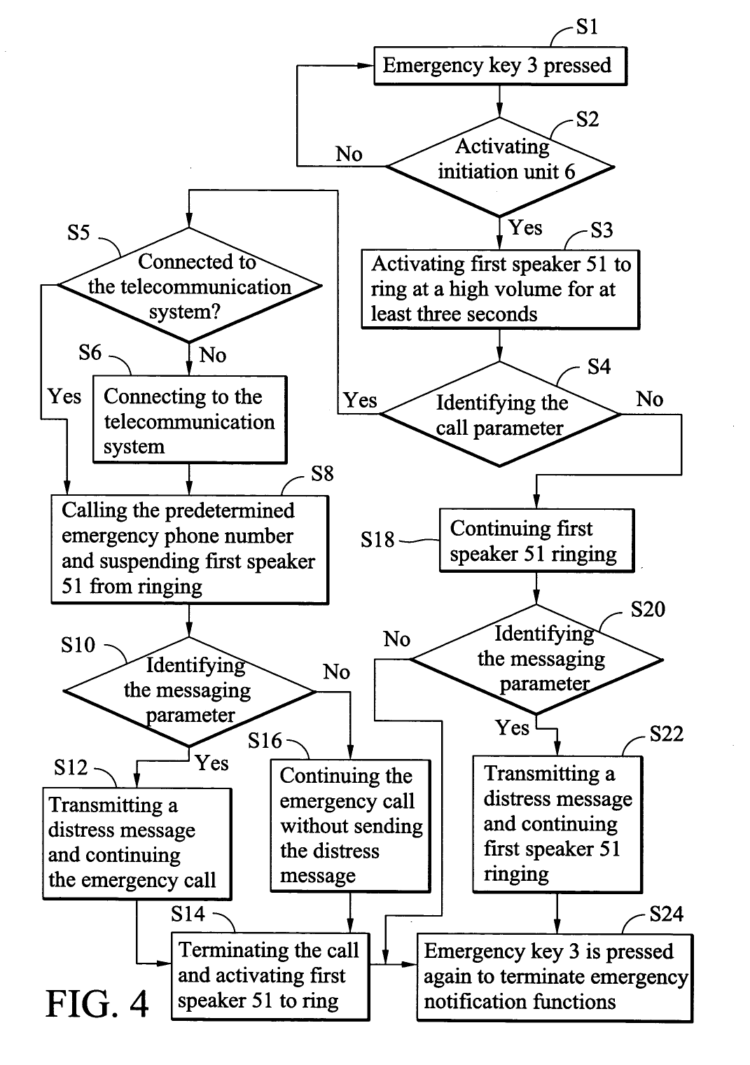

FIG. 4 is a flowchart of the emergency notification method of the invention.

Emergency key 3 must be pressed for at least a predetermined period, such as three seconds, to activate initiation unit 6 and implement the emergency notification process.

Input controller 2 detects whether emergency key 3 is pressed or released and transmits corresponding signals to processing unit 1. When detecting that emergency key 3 is pressed (step S1), input controller 2 transmits a button-down signal to processing unit 1. If processing unit 1 does not receive a button-up signal three seconds after receiving the button-down signal, processing unit 1 identifies that emergency key 3 has been pressed for at least three seconds and the initiation condition is satisfied. In other words, processing unit 1 determines that initiation unit 6 has been activated (step S2). After determining that the initiation condition has been satisfied, processing unit 1 implements the emergency notification process. The emergency notification process is described in the following, wherein a plurality of emergency notification functions are automatically executed.

First, processing unit 1 automatically activates first speaker 51 to emit a high volume ring tone for at least three seconds (step S3).

After activating first speaker 51 to emit a high volume ring tone for at least three seconds, processing unit 1 performs emergency communication functions based on the predetermined data. Processing unit 1 identifies the call parameter (step S4).

If the value of the call parameter is “1”, processing unit 1 determines whether communication unit 7 is connected to the telecommunication system (step S5). If so, processing unit 1 performs step S8. If not, processing unit 1 connects communication unit 7 to the telecommunication system (step S6) and then performs step S8.

For example, base station 31 and 32 belong to a first wireless service provider and a second wireless service provider respectively. If mobile phone 10 is predetermined to be served by the first wireless service provider when switched on, mobile phone 10 connects to base station 31. When leaving radio coverage range of base station 31 and within radio coverage range of base station 32, mobile phone 10 is disconnected from the telecommunication system as it is no longer served by the first wireless service provider. The emergency phone number, however, can be called by connecting to any surrounding base station of mobile phone 10. In other words, even though base station 32 does not belong to the first wireless service provider, mobile phone 10 can connect the telecommunication system and call the predetermined emergency phone number through base station 32.

In step S8, processing unit 1 executes a call to the predetermined emergency phone number and suspends ringing of first speaker 51 (step S8). Processing unit 1 then identifies the message parameter (step S10). If the value of the message parameter is “1”, processing unit 1 transmits a distress message and continues the emergency call (step S12). If the value of the message parameter is “0”, processing unit 1 continues the emergency call without sending the distress message (step S16). When determining the emergency call is complete, processing unit 1 activates first speaker 51 to emit a high volume ring tone again (step S14) until emergency key 3 is pressed again for the predetermined period (step S24).

During the emergency call process, processing unit 1 calls and reads the predetermined emergency phone number from memory 4 and activates first speaker 51 as the loudspeaker for output, at a high volume, of voice data received from a connected recipient terminal of the predetermined emergency phone number. Thus, the user can communicate with the recipient without opening the hinged cover. The predetermined emergency phone number may be “112” or others stored in memory 4 in advance.

If the value of the call parameter is “0”, processing unit 1 will not execute the emergency call, but first speaker 51 will continue to ring (step S18). Processing unit 1 then identifies the message parameter (step S20). If the value of the message parameter is “1”, processing unit 1 sends a distress message and continues first speaker 51 to ring (step S22). If the value of the message parameter is “0”, processing unit 1 directs first speaker 51 to continue ringing without transmitting the distress message. First speaker 51 will not stop ringing until emergency key 3 is pressed again for the predetermined period (step S24).

In the process of sending the distress message, processing unit 1 reads predetermined message addressees and predetermined messages. The predetermined message addressees typically comprise phone numbers of mobile phones. Unless at least one predetermined message addressee is stored in memory 4 in advance, no distress message is sent. If a plurality of predetermined message addressees is stored in memory 4, the distress message is sent thereto respectively. The content of the distress message comprises a predetermined message stored in memory 4 and composed by the user in advance or by the manufacturer of the mobile phone 10. When no user-defined predetermined message is present in memory 4, processing unit 1 reads and sends a default predetermined distress message.

When initiated, the emergency notification functions are terminated when emergency key 3 is pressed again for the predetermined period. Input controller 2 detects whether emergency key 3 is pressed or released and transmits corresponding signals to processing unit 1. When detecting that emergency key 3 is pressed, input controller 2 transmits a button-down signal to processing unit 1. If processing unit 1 has not received a button-up signal three seconds after receiving the button-down signal, processing unit 1 determines that emergency key 3 has been pressed for at least three seconds and that the emergency notification function is still in process. Thus, processing unit 1 determines that a termination condition is satisfied. The emergency notification functions are terminated when the termination condition is satisfied.

By requiring the predetermined key-press duration, an embodiment of the invention prevents accidental initiation of the emergency notification process. Accidental initiation, however, can be prevented using other methods. For example the emergency notification functions are initiated when two specified keys are pressed simultaneously, an emergency key is pressed for four times in succession, or the emergency key is pressed and a specified voice signal is received by a voice control device of the mobile phone 10 simultaneously. Similarly, the termination condition can be defined accordingly. Initiation unit 6 may comprise other devices for activating the emergency notification functions. Other initiation units may be activated in various ways based on an initiation condition corresponding thereto.

In the above description of the emergency notification method, initiation unit 6 is activated after mobile phone 10 has been switched on. The emergency key 3, however, may be implemented as an additional button adjacent to the original power button of mobile phone 10. For example, emergency key 3 may act as a power button of mobile phone 10. In this case, if mobile phone 10 is off, as soon as emergency key 3 is pressed, mobile phone 10 is powered on, the initiation unit 6 is activated, and the emergency notification process is then executed as previously described.

Mobile phone 10 may further comprise an image capture device for capturing still images or video clips. The image capture device is coupled to processing unit 1. When receiving an initiation signal, such as the button-down signal, processing unit 1 captures a still image or a video clip using the image capture device and treats the still image or the video clip as the content of the distress message. When the initiation condition is satisfied, processing unit 1 sends the distress message comprising the still image or the video clip to the predetermined message addressees through communication unit 7.

Similarly, when receiving the initiation signal, processing unit 1 may record an audio clip using the audio input unit 9 and use the audio clip as the content of the distress message. When the initiation condition is satisfied, processing unit 1 sends the distress message comprising the audio clip to the predetermined message addressees through communication unit 7.

In addition, some recipient terminals lack the capability to receive a message comprising an image, a video clip, or an audio clip. In order to address the situation, a text message is sent with the image, the video clip or the audio clip. The text message may comprise a general purpose predetermined distress message which is composed and stored by the user in advance or by the manufacturer of the mobile phone 10 in memory 4.

In addition, mobile phone 10 may further comprise a flashlight for producing a bright flash of light. The flashlight is coupled to processing unit 1. When receiving the initiation signal, processing unit 1 directs the flashlight to generate several bursts of light sequentially. The predetermined data may further comprise photo parameters, video parameters, audio parameters and flash parameters for recording a user configuration. Processing unit 1 captures and sends an image, a video clip and an audio clip and activates the flashlight based on the photo parameters, video parameters, audio parameters and flash parameters.

In the above description, ring signals and voice signals are both output from first speaker 51. To prevent the emergency call from being disturbed by the ring tone, ringing of first speaker 51 is suspended as soon as the predetermined emergency phone number is called. Suspension of the ring tone, however, can be achieved by other means. For example, processing unit 1 may suspend output of the ring tone from first speaker 51 after mobile phone 10 has connected to a recipient terminal or after the recipient terminal is answered and the system tone or voice signal is then output through first speaker 51 accordingly.

Although the telecommunication system conforming to GSM protocol is given as an example, the emergency notification method of embodiments of the invention may be implemented in other systems.

Even if additional services are not ordered by the user or provided by a wireless service provider thereof, mobile phone 10 can perform the emergency notification method of the invention to call the emergency phone number or send a distress message.

In conclusion, in the emergency notification system of embodiments of the invention, when the initiation condition thereof is satisfied, ringing, calling, and messaging functions are issued thus providing the described functions.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An emergency notification method, implemented in a mobile communication device capable of wireless connection to a telecommunication system providing telephone and messaging service, wherein the mobile communication device comprises an initiation device, comprising the steps of:
activating the initiation device to automatically initiate the following emergency notification steps;
activating a speaker of the mobile communication device to emit a high volume ring tone;
identifying at least a predetermined parameter to determine whether to send a predetermined distress message through the telecommunication system; and
if it is determined that the predetermined distress message is to be sent by the mobile communication device, transmitting the predetermined distress message through the telecommunication system.

2. The method as claimed in claim 1, wherein the predetermined parameter comprises a message parameter, and the predetermined distress message comprises a text message conforming to short messaging services protocol.

3. The method as claimed in claim 1, wherein the predetermined parameter comprises a photo parameter, and the transmitting step further comprises the steps of:
capturing an image; and
transmitting the image through the telecommunication system based on the photo parameter.

4. The method as claimed in claim 1, wherein the predetermined parameter comprises a video parameter, and the transmitting step further comprises the steps of:
capturing a video clip; and
transmitting the video clip through the telecommunication system based on the video parameter.

5. The method as claimed in claim 1, wherein the predetermined parameter comprises an audio parameter, and the transmitting step further comprises the steps of:
recording an audio clip; and
transmitting the audio clip through the telecommunication system based on the audio parameter.

6. The method as claimed in claim 1, wherein the predetermined parameter comprises a call parameter, and the method further comprises the step of calling a predetermined emergency phone number based on the call parameter.

7. The method as claimed in claim 1, further comprising the steps of:
determining whether a termination condition of the initiation device is satisfied; and
if the termination condition is satisfied, suspending emergency process triggered by the initiation device, comprising at least ringing of the speaker or transmission of the distress message.

8. A mobile communication device, capable of wireless connection to a telecommunication system providing telephone and messaging service, comprising:
an input device for initiating emergency notification functions;
a speaker for emitting audio signals;
a memory storing at least a predetermined parameter;
a communication unit for wireless communication; and
a processing unit coupled to the input device, the speaker, the memory, and the communication unit, wherein, when the input device is activated, the processing unit automatically directs the speaker to emit a high volume ring tone, identifies the predetermined parameter to determine whether to send a predetermined distress message through the telecommunication system, and transmits the predetermined distress message through the communication unit and the telecommunication system if the processing unit determines that the distress message is to be sent by the mobile communication device.

9. The device as claimed in claim 8, wherein the predetermined parameter comprises a message parameter, and the predetermined distress message comprises a text message conforming to short messaging services protocol, the content of which is stored in the memory in advance.

10. The device as claimed in claim 8, wherein the predetermined parameter comprises a photo parameter, the mobile communication device further comprises an image capture device for capturing images, and the processing unit further automatically captures an image using the image capture device and transmits the image through the telecommunication system based on the photo parameter when the input device is activated.

11. The device as claimed in claim 8, wherein the predetermined parameter comprises a video parameter, the mobile communication device further comprises an image capture device for capturing video clips, and the processing unit further automatically captures a video clip using the an image capture device and transmits the video clip through the telecommunication system based on the video parameter when the input device is activated.

12. The device as claimed in claim 8, wherein the predetermined parameter comprises an audio parameter the mobile communication device further comprises an audio input unit for recording audio clips, and the processing unit further automatically records an audio clip using the audio input unit and transmits the audio clip through the telecommunication system based on the audio parameter when the input device is activated.

13. The device as claimed in claim 8, wherein the predetermined parameter comprises a call parameter, and the processing unit further calls a predetermined emergency phone number using the communication unit based on the call parameter.

14. The device as claimed in claim 8, wherein the mobile communication device further comprises a flashlight for emitting bursts of bright light, the processing unit further automatically activates the flashlight when the input device is activated.

15. The device as claimed in claim 8, wherein the mobile communication device is powered on when the input device is activated.
